(19) United States
(12) Patent Application Publication
(10) Pub. No.: US 2018/0363891 A1
(43) Pub. Date: Dec. 20, 2018

(54) Light Strip Drive Circuit of LED Three-Copper-Wire Light

(71) Applicant: Shenzhen Huatuo Lighting Co., Ltd., Shenzhen (CN)

(72) Inventor: Ruiyang Tang, Shenzhen (CN)

(73) Assignee: Shenzhen Huatuo Lighting Co., Ltd., Shenzhen (CN)

(21) Appl. No.: 15/688,661

(22) Filed: Aug. 28, 2017

(30) Foreign Application Priority Data
Jun. 15, 2017 (CN) 201720694034.4

(51) Int. Cl. F21V 23/00; H05B 33/08; H02J 7/00

(52) U.S. Cl. CPC F21V 23/001; H05B 33/0842; F21Y 2115/10; H02J 7/008; H02J 7/0068

(57) ABSTRACT

The present invention discloses a light strip drive circuit of LED three-copper-wire light including a battery controller, a charging port P, a three-copper-wire light A and a three-copper-wire light B; output terminals DATE1, DATE2, and DATE3 of the battery controller are connected to three ends of the three-copper-wire light A and of the three-copper-wire light B, respectively; an input terminal +5V of the battery controller is connected to a switch K and an interface V+ of the charging port P; an input terminal GND of the battery controller is connected to a resistor R and an interface GND of the charging port P; and an other end of the resistor R is connected to an other end of the switch K. In the present invention, the LED light beads are welded on the copper wires, and the anode and cathode of the LED light bead chips R, G and B are attached to the three wires of the light beads by spot welding as needed, such that fracture and malfunction of the light strip occurring during use can be effectively avoided. Moreover, the three-wire connection is material-saving and labor-saving.

### TECHNICAL FIELD

The present invention relates to a drive circuit, particularly to a light strip drive circuit of LED three-copper-wire light.

### BACKGROUND OF THE INVENTION

In view of the damage during use and the diversity of individual functions of a product, the light strip of existing LED shoe light is prone to low bending strength, malfunction and the like in use. Previously, FPC flexible printed circuit board (PCB) is generally used, in which a steel plate is attached to the back surface of the PCB to protect the light strip. However, an irreparable damage may happen to the strip light easily due to the mechanical movement of walking when the shoe light is used, resulting in damage of the strip light. Accordingly, it is desired for solutions to the problem for years in the related art. To this end, a light strip is developed based on replacing the FPC board with the three copper wires. The three copper wires are cost-effective and bending endurable, as well as being compatible with the illumination mode of the original 4-wire and 5-wire LED RGB shoe light. Therefore, the damage problem of the light strip of the LED shoe light needs to be addressed.

### SUMMARY OF THE INVENTION

The object of the present invention is to provide a light strip drive circuit of LED three-copper-wire light to solve the problems raised in the aforementioned background.

In order to achieve the above object, the present invention provides the following technical solution:

A light strip drive circuit of LED three-copper-wire light including a battery controller, a charging port P, a three-copper-wire light A and a three-copper-wire light B; output terminals DATE1, DATE2, and DATE3 of the battery controller are connected to three ends of the three-copper-wire light A and of the three-copper-wire light B, respectively; an input terminal +5V of the battery controller is connected to a switch K and an interface V+ of the charging port P; an input terminal GND of the battery controller is connected to a resistor R and an interface GND of the charging port P; and an other end of the resistor R is connected to an other end of the switch K.

As a further aspect of the present invention, the three-copper-wire light A is in 4020 A package.

As a further aspect of the present invention, the three-copper-wire light B is in 4020 B package.

As a further aspect of the present invention, the three-copper-wire light is an LED light strip.

As a further aspect of the present invention, the output terminals of the battery controller is connected to an MCU control circuit, and the MCU control circuit is further connected to a charging and discharging management circuit.

As a further aspect of the present invention, the battery controller is controlled by a programmable MCU (SOP-14).

Compared to the prior art, the beneficial effects of the present invention are that: in the present invention, the LED light beads are welded on the copper wire, and the anode and cathode of the LED light bead chips R, G and B can be attached to the three wires of the light beads by spot welding as needed, such that fracture and malfunction of the light strip occurring during use can be effectively avoided; moreover, the three-wire connection is material-saving and labor-saving.

### BRIEF DESCRIPTION OF THE DRAWINGS

FIG. 1 is a schematic diagram of a drive circuit of an LED three-copper-wire shoe light according to the present invention;

FIG. 2 is a circuit diagram of a button-USB integrated switch;

FIG. 3 is a schematic diagram of an MCU drive;

FIG. 4 is a pin diagram of the MCU;

FIG. 5 is a welding schematic diagram of a chip of 4020 A type of light beads in floating state;

FIG. 6 is a welding schematic diagram of a chip of 4020 B type of light beads in floating state.

### DETAILED DESCRIPTION OF THE INVENTION

The technical solutions in embodiments of the present invention will be described in detail below with reference to the drawings in the embodiments of the present invention. Obviously, the described embodiments are mere some of examples rather than all embodiments of the present invention. Each of the other embodiments obtained by those skilled in the art without creative effort falls within the protective scope of the present invention, based on the embodiments of the present invention.

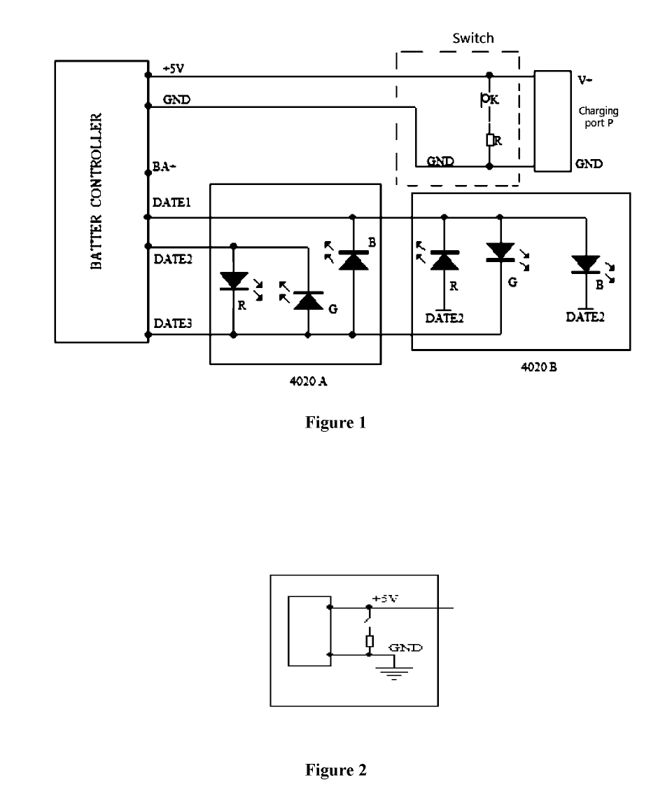

With reference to FIGS. 1-6, the embodiment of the present invention provides a light strip drive circuit of LED three-copper-wire light including a battery controller, a charging port P, a three-copper-wire light A and a three-copper-wire light B; output terminals DATE1, DATE2, and DATE3 of the battery controller are connected to three ends of the three-copper-wire light A and of the three-copper-wire light B, respectively; an input terminal +5V of the battery controller is connected to a switch K and an interface V+ of the charging port P; an input terminal GND of the battery controller is connected to a resistor R and an interface GND of the charging port P; and an other end of the resistor R is connected to an other end of the switch K.

The three-copper-wire light A is in 4020 A package.

The three-copper-wire light B is in 4020 B package.

The three-copper-wire light is an LED light strip.

The output terminal of the battery controller is connected to an MCU control circuit, and the MCU control circuit is further connected to a charging and discharging management circuit.

The working principle of the present invention is that, the battery controller is triggered by a button-USB two-in-one switch to control the operation of the circuit, and the battery controller controls the voltage of the output terminals DATE1, DATE2 and DATE3 through level (i.e. high and low levels) of the IO port and time so as to achieve a normal operation of the three-copper-wire light.

As shown in FIG. 2, with the button-USB integrated switch, the battery is actuated by slightly pressing the button of the switch, and the USB interface enters the charging mode once a voltage of 5V is applied.

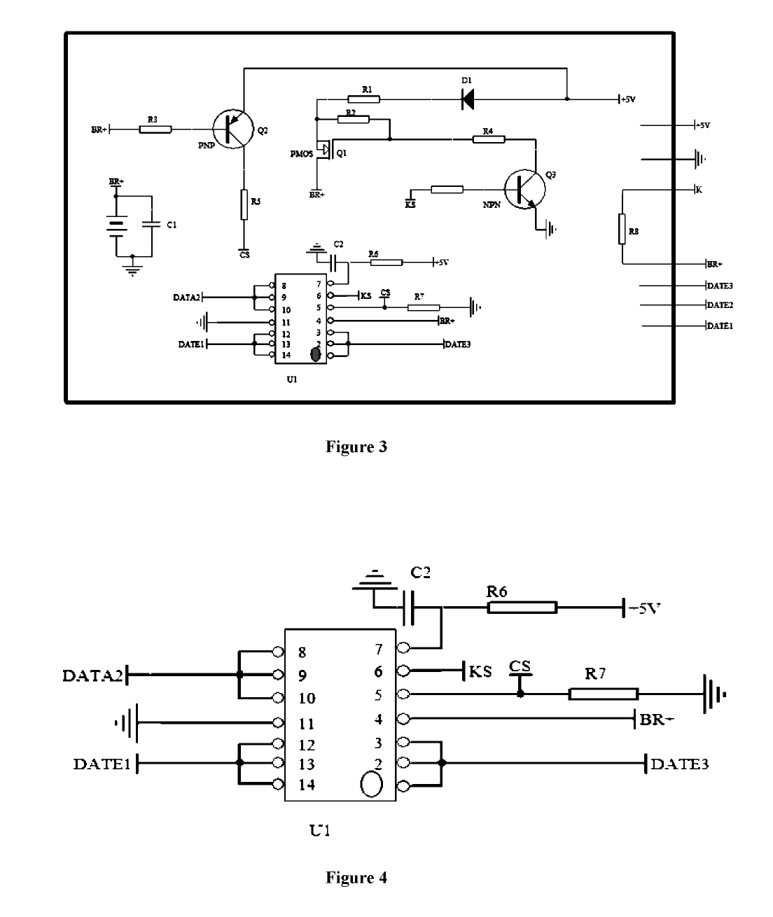

As shown in FIG. 3, the battery controller controls the turn-on time of circuit and the output terminal voltage of the battery controller by adjusting the high and/or low levels of the IO port, such that the high and/or low voltage are applied to the three ends of the three-copper-wire light. Moreover, the voltage of the charging and discharging is detected through a CS pin to reach an overcharge and overdischarge of the battery.

As shown in FIG. 4, a pin diagram of the MCU is shown, in which pins 1-3 are connected to DATE3 (three AO ports have a stronger drive ability), pin 4 is connected to the anode of the battery, pin 5 is a trigger pin for switch button, pin 6 is a feedback pin for the detected voltage (for detecting the overcharge and overdischarge of the battery), pin 7 is connected to the charging port +5v, pins 8-10 are connected to DATE2, pin 11 is connected to the ground, and pins 12-14 are connected to DATE1.

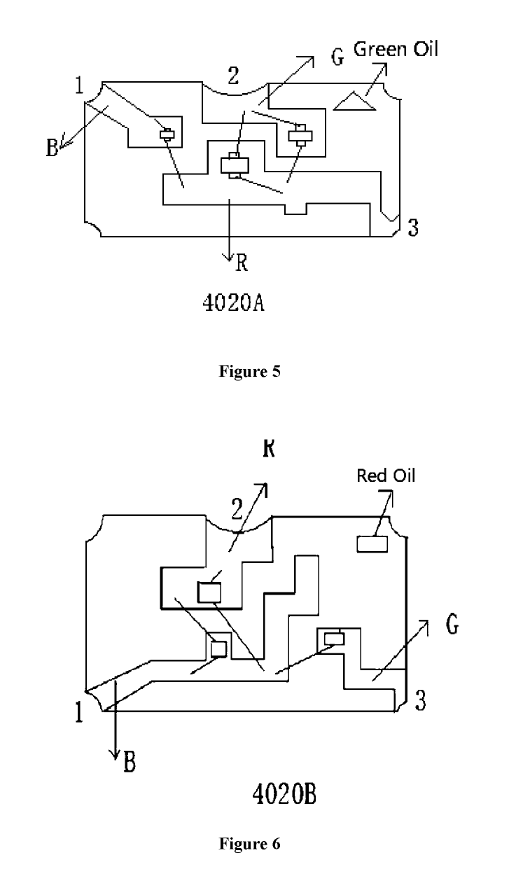

As shown in FIGS. 5-6, the anode and cathode of the copper-wire light chips R, G and B were fixedly welded at the three pins within the 4020-type light beads, and two types of package, 4020 A and 4020 B, are used for the light beads as needed.

It will be apparent to those skilled in the art that the present invention is not limited to the details of the above-described exemplary embodiments, and the present invention can be realized in other specific forms without departing from the spirit or essential characteristics of the present invention. Accordingly, the embodiments should be considered as examples and are not limited from any point of view. Moreover, the scope of the present invention is defined by the appended claims rather than by the foregoing description, thus the present invention is intended to cover all variants within the meaning and scope of the appended claims and their equivalent elements. Any reference designators in the claims should not be construed as limitation for the claims.

In addition, it should be appreciated that this disclosure is described in terms of embodiments, but not every embodiment therein includes only one independent technical solution. The way of describing the disclosure is merely for the sake of clarity, and the description should be considered as a whole. The technical solutions in the various embodiments may also be adequately combined to form other embodiments which are conceivable to those skilled in the art.

1. A light strip drive circuit of LED three-copper-wire light comprising a battery controller, a charging port P, a three-copper-wire light A, and a three-copper-wire light B, wherein
output terminals DATE1, DATE2, and DATE3 of the battery controller are connected to three ends of the three-copper-wire light A and of the three-copper-wire light B, respectively;
an input terminal +5V of the battery controller is connected to a switch K and an interface V+ of the charging port P;
an input terminal GND of the battery controller is connected to a resistor R and an interface GND of the charging port P; and
an other end of the resistor R is connected to an other end of the switch K.

2. The light strip drive circuit of LED three-copper-wire light of claim 1, wherein the three-copper-wire light A is in 4020 A package.

3. The light strip drive circuit of LED three-copper-wire light of claim 1, wherein the three-copper-wire light B is in 4020 B package.

4. The light strip drive circuit of LED three-copper-wire light of claim 1, wherein the three-copper-wire light is an LED light strip.

5. The light strip drive circuit of LED three-copper-wire light of claim 1, wherein an output terminal of the battery controller is connected to an MCU control circuit, and the MCU control circuit is further connected to a charging and discharging management circuit.

6. The light strip drive circuit of LED three-copper-wire light of claim 1, wherein the battery controller is controlled by a programmable MCU (SOP-14).
